(19) United States
(12) Patent Application Publication
(10) Pub. No.: US 2023/0222613 A1
(43) Pub. Date: Jul. 13, 2023

(54) PREDICTING CUSTOMER CHANGE OF ADDRESS BASED ON WEB BROWSING ACTIVITY AND TRANSACTIONS

(71) Applicant: Capital One Services, LLC, McLean, VA (US)

(72) Inventors: Allison Fenichel, Brooklyn, NY (US); Sander Henning, San Francisco, CA (US); Michael Holden, San Jose, CA (US)

(21) Appl. No.: 17/571,687

(22) Filed: Jan. 10, 2022

(51) Int. Cl. G06Q 50/26; G06N 20/00

(52) U.S. Cl. CPC G06Q 50/265; G06N 20/00

(57) ABSTRACT

Aspects provided may allow for the determination that a consumer has changed an address based on the consumer's online transactions. By obtaining corresponding data for a consumer for each online transaction and providing location data to a machine-learning model, which is configured to evaluate the likelihood that a consumer has changed addresses based on location data records associated with consumer online activity, the model may generate a prediction that a consumer has changed their address. Based on this prediction, a change of address process for the consumer may be initiated. Further aspects provide methods of obtaining the location information, methods of generating supplemental location data based on a consumer's in-person transactions, and training a machine-learning model.

### FIELD OF USE

Aspects of the disclosure relate generally to models in computer systems that track user actions. More specifically, aspects of the disclosure may provide for enhanced detection of user address changes, based on user activity while browsing the internet and making online purchases.

### BACKGROUND

Financial institutions have an interest in knowing the current addresses of their users so they can ensure security, detect potential fraud, and contact customers with updated financial information if necessary.

One major reason for knowing accurate and current addresses is communication: financial institutions need to be able to mail consumers updates, ship new credit and debit cards before a current card expires, replace credit and debit cards if a number associated with one is frozen, and more. In these cases, an incorrect address could lead to serious delays in service. As an example, a customer who needs a new credit card due to their previous credit card number being stolen wants to receive their new card within one to two business days of their old card being frozen. If the customer does not receive their card in this time frame, they may seek out a new credit card provider that will provide quicker service or otherwise meet their needs. Being able to detect if a consumer has changed their address and, if so, what the new address is, would avoid the above situation and any others that depend on an accurate shipping address.

However, consumers have the burden of updating their mailing address whenever undergoing a change of address, such as moving to a new home or business location. Often, customers forget to update their mailing address at every organization which needs their address. The process of moving is often difficult and time-consuming Typically, the consumer is solely responsible for updating their address with many different entities, such as: the department of motor vehicles, the United States Postal Service (USPS), medical insurance, medical provider offices, online merchants, financial institutions, and many more. As a result, it is easy for a consumer to forget to update their address at one or more of the many organizations, and weeks or months may pass before the consumer remembers to update their address at one or more organizations with the new address.

Organizations, such as financial institutions, would benefit from being able to detect a consumer's change of address without being forced to depend on the consumer to manually update the address. Such detection would allow the financial institution to operate with more confidence that the address on file for a given consumer were correct and could be trusted when mailing important financial items and documents. Non-financial institutions would also benefit if a change of address could be detected.

In recent years, it has become very common for users to purchase goods or services online and have those goods or services delivered to a physical address. These online purchases generate a wealth of consumer information, such as the identity of the merchant the goods or services were purchased from, the type and quantity of goods or services purchased, what was used to pay for the purchase (e.g., debit card, credit card, etc.), and more. In many cases, these online purchases also include a shipping address where the goods or services are to be delivered, and a billing address associated with the account making the purchase.

Often, the shipping address is the consumer's home address, but the address may also be a work address or another address associated with the consumer.

Similarly, consumers are often required to pay online at the time of placing the order, most commonly through the use of a credit card. To protect against fraud, online credit card purchases often require the consumer to provide the billing address associated with the credit card used for the purchase. This address, similar to the shipping address, is often the consumer's home address, but may be a work address or another address associated with the consumer.

Consumers may also, rather than entering a shipping address, enter or select a pickup location from locations predetermined by the merchant or by another entity. These addresses, while not corresponding exactly to the consumer, may also indicate the general geographic region that the consumer is acting in.

The information associated with online purchases can be, and has been used to detect changes in consumer behavior that may indicate a major life event. Such information may also be used to detect fraud, in cases where the change in consumer behavior is significant enough that it is deemed unlikely to be a legitimate transaction. However, the volume and diversity of data associated with online purchases make the data very difficult to parse into actionable information.

It would be additionally useful for a financial institution to be able to detect a change of address and distinguish this life event from a temporary relocation, such as a vacation or long-term assignment, and thus detect a fraudulent purchase. One potential signifier of fraud is a shipping or billing address different from the address that is on file for a given consumer. If the financial institution could instead detect that the consumer had merely moved, rather than the consumer having had their financial information stolen by an outside actor, the financial institution could reduce false positives in a fraud detection model while simultaneously meeting the business need of having current addresses for each consumer.

To complicate matters further, financial institutions do not often have access to the shipping and billing addresses, or any other consumer location information used to complete an online purchase. Instead, the financial institution may have a purchase record on the consumer's account, indicating the merchant, the amount spent, and other information. However, this purchase record would not ordinarily contain any shipping information, or billing information outside of the identifier for the account used to make the purchase. As a result, the financial institution does not have access to the very information the financial institution requires to determine if a consumer has changed an address.

By contrast, a merchant website where a consumer makes a purchase often does have information about the users who visit and make purchases at their website, including the addresses needed for shipping and billing. In addition to addresses, merchant websites may also collect information such as a user's name and contact information, the IP address of the device the user accessed the website from, the pages that the user accessed, and more. The merchant operating the website may use this information for the merchant's business purposes. The merchant may also save information associated with a purchase, such as: an order number, a list of goods purchased and quantities thereof, partial or full information about the payment method used to purchase the order, shipping addresses, billing addresses, and more.

However, a given website does not often share a consumer's personal information with other entities, especially information that may be used for web authentications or which could be used to identify the consumer. While there are cases of breaches, in which information about a website's users is stolen, websites and the organizations will usually attempt to keep such information secure and not share the information with other entities without user permission.

Third-party websites, defined as any website not operated by the party receiving information from the extension, do not normally share user information with other parties, especially financial and location data used for online orders. If third-party websites do share information with others, the third-party websites do so only under data sharing agreements.

For a party that wishes to collect online browsing and purchase information for the party's users, it would be impractical to form a data sharing agreement with each possible third-party website that any one user might access.

Additionally, data sharing agreements often require a user's data to be anonymized when the data is shared with external parties. In this case, where a party is trying to identify whether a given user has changed addresses, anonymized information would be difficult, if not impossible to use; determining whether a user have changed addresses depends on data that is known to be connected to that user. De-anonymizing information to associate the information with a user again might be possible, but would be time and resource intensive.

For these two reasons, a party that wishes to collect user browsing information from third-party websites and is able to do so independently, without forming data sharing agreements with each possible third-party website, would save time, money, and resources that otherwise might have been devoted to those third-party agreements. The party would also be able to control the format of the information as it is being collected, which would additionally save time and resources by reducing the amount of data cleanup necessary to make the information usable.

In addition to collecting online purchase information, a party may also wish to collect information from a user's in-person transactions at physical locations. These physical locations could supplement online-only information about the user, and allow a party to compare the physical locations of a store that a user chooses to patronize to the user's known addresses.

### SUMMARY

The following presents a simplified summary of the various aspects described herein. This summary is not an extensive overview and is not intended to identify key or critical elements or to delineate the scope of the claims. This summary merely presents some concepts in a simplified form as a prelude to more detailed descriptions below.

Aspects described herein describe a computer-implemented method for determining a user change of address based on the collection and evaluation of user location data. According to some aspects, the method may involve collecting user location data associated with web activity by the user via browser extension. The method then involves generating a plurality of location data records over time that are associated with the user. The method then involves configuring a machine-learning model, based on prior sets of browsing data collected from users that had a known change of address, and generating, based on the plurality of records associated with the user, a prediction as to whether the user had a change of address. The method then involves initiating a change of address review process for the user at the party that provided the browser extension.

Some aspects described herein may provide for a system for determining if a user has undergone a change of address. The system may include one or more processors and memory storing instructions that, when executed, cause the system to perform the follow operations: receive, via a browser extension, location data associated with the user based on user browsing activity; generate a plurality of location data records associated with the user browsing activity over time; generate, by a machine learning model configured to predict a change of address based on prior pluralities of location data records; generate a prediction that the user has changed an address; and initiate a change of address for the user.

Corresponding apparatuses, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited to the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an illustrative flow chart of the location data as it is collected by the browser extension, compiled into a plurality of location data records, analyzed by the machine-learning model, and used to generate a prediction as to whether the user has undergone a change of address;

FIG. 3 is a flowchart representation of a general method for FIG. 2, in which the browser extension collects location data while the user browses the third-party website;

FIG. 4 is a flowchart representation of the method for several embodiments of FIG. 3, showing several different examples of how the browser extension retrieves the location data corresponding to the user browsing activity;

FIG. 5 is a flowchart representation of other embodiments of FIG. 3, in which the browser extension scrapes a shipping address or billing address from an online order page, using that address as the location data;

FIG. 6 is an environmental representation of FIG. 5, showing an example order form that the browser extension would scrape to obtain location data;

FIG. 7 is a schematic representation of the movement of user location data from user web activity to the machine-learning model.

FIG. 8 is a flowchart representation of the method for configuring, using, and updating the machine-learning model for determining if a user has changed addresses; and

FIG. 9 is a structural representation of a supplemental mechanism for obtaining user location data from in-person transactions by the user at a physical location;

FIG. 10 is a flowchart representation of the supplemental mechanism for obtaining user location data from in-person transactions by the user at a physical location, showing several different examples of how the in-person location data may be obtained based on the in-person transaction information.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of illustration and should not be regarded as limiting. Rather, the phrases and terms used herein are to be given their broadest interpretation and meaning.

Aspects discussed herein may relate to methods and techniques for obtaining user location data from web activity by the user and analyzing that location data in a machine-learning model to determine if the user has changed addresses. Based on records associated with the user, the machine learning model analyzes the location data makes a prediction whether a user has changed their address. If the machine learning model predicts that a user has changed their address, a change of address process for the user is initiated.

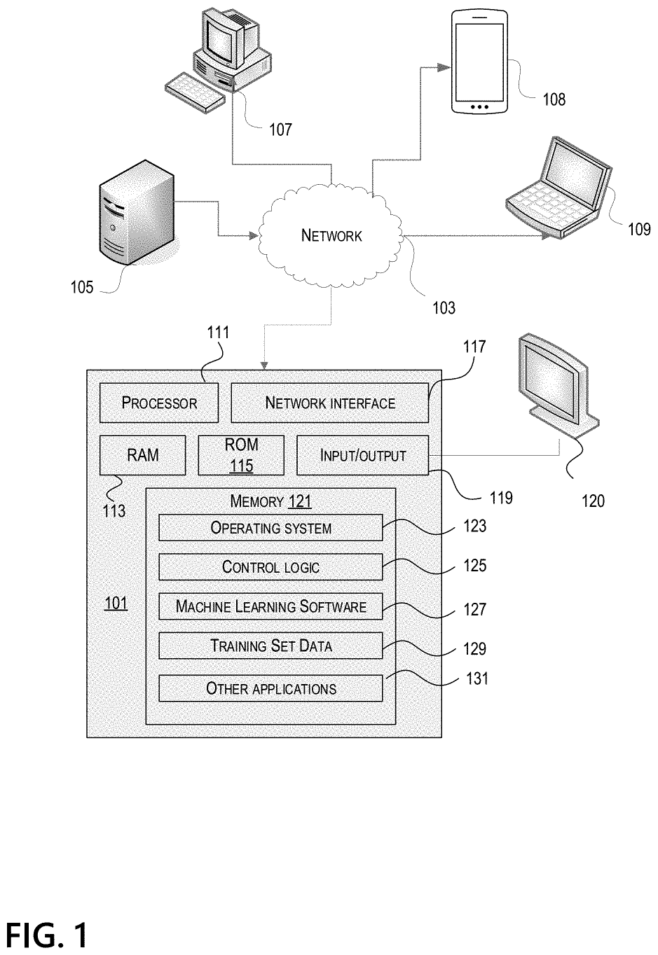

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smartphone, any other types of mobile computing devices, and the like), and/or any other type of data processing device.

Computing device 101 may, in some embodiments, operate in a standalone environment. In other embodiments, computing device 101 may operate in a networked environment. As shown in FIG. 1, various network nodes 101, 105, 107, 108, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 108, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 108, 109 may have similar or different architecture as described with respect to computing device 101. Those of skill in the art will appreciate that the functionality of computing device 101 (or device 105, 107, 108, 109) as described herein may be spread across multiple data processing devices, for example, to distribute processing load across multiple computers, to segregate transactions based on geographic location, user access level, quality of service (QoS), etc. For example, devices 101, 105, 107, 108, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

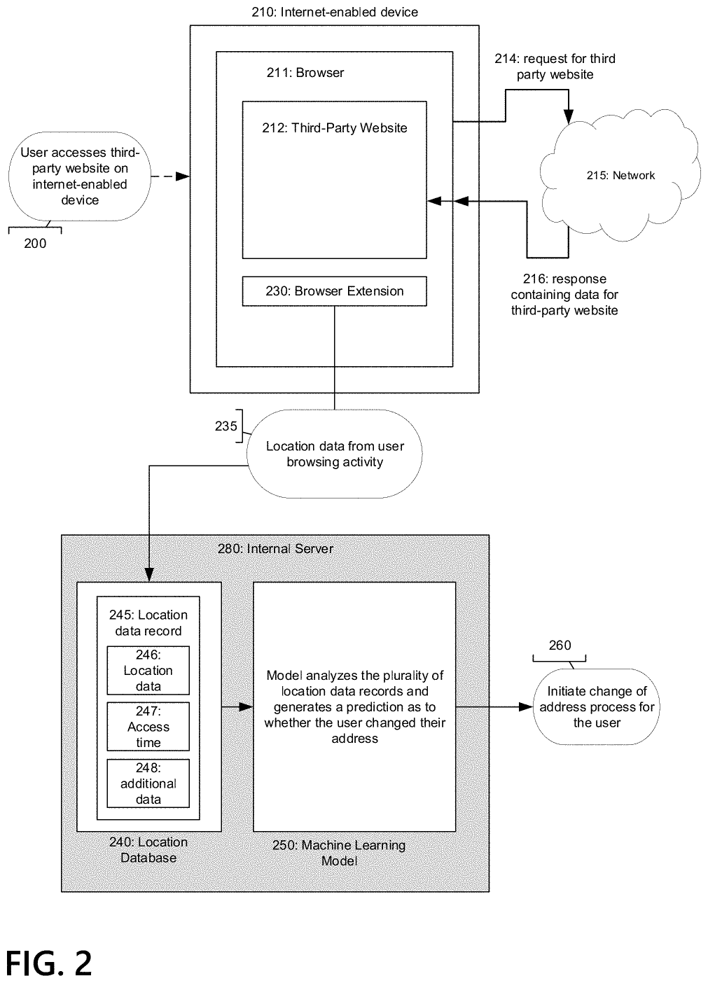

FIG. 2 illustrates the system in which location data may be collected via a browser extension from the user web activity, compiled into records, and analyzed by the machine-learning model.

In step 200, the user accesses a third-party website 212 on an internet-enabled device 210. On internet-enabled device 210, the browser 211 initiates a page request in step 214 for the third-party website 212 to the network 215. The browser 211 in step 216 receives the page response containing the data for the third-party website 212 and displays the website.

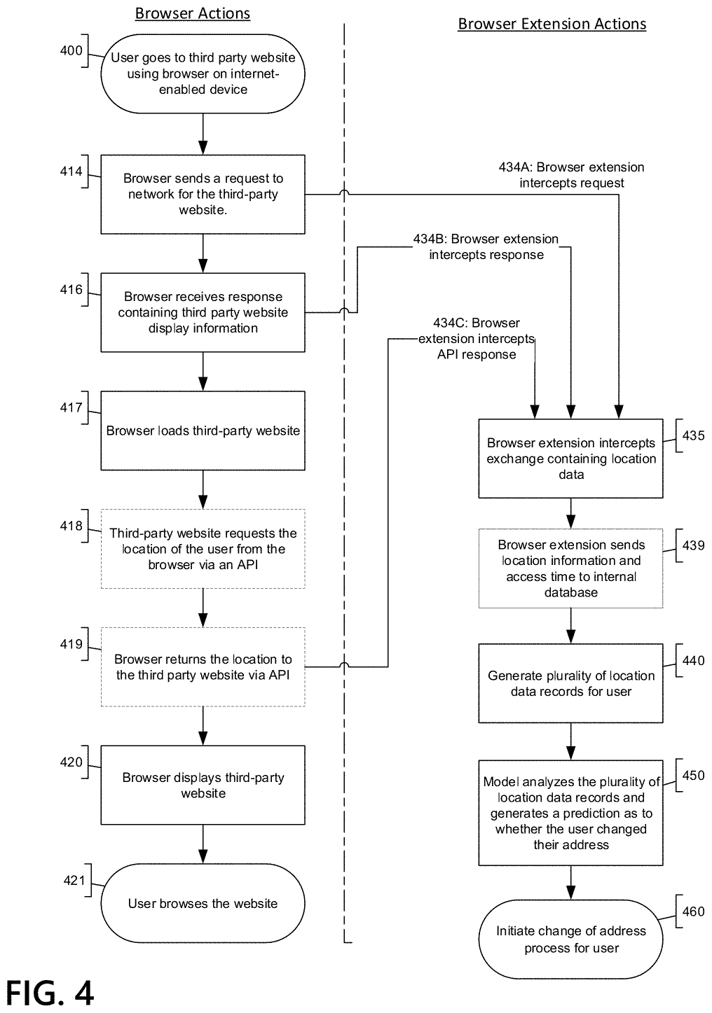

Browser extension 230 in step 235 extracts the user location data from the user access of the third-party website 212. The browser extension 230 may complete this task in various different embodiments, several of which will be discussed in FIG. 4. In some embodiments, browser extension 230 may be owned and operated by the same party which owns and operates third-party website 212. In other embodiments, browser extension 230 may be operated by a second party, working on behalf of the party making the change of address determination.

Browser extension 230 sends the user location data 246 to a location database 240 on internal server 280. In some embodiments, the internal server 280 and location database 240 may be operated by the same party which operates browser extension 230. Internal server 280 and location database 240 may also be operated by a third-party hosting service, a software-as-a-service (SaaS) company, or a similar entity working on behalf of the party making the change of address determination.

For each transaction, a location data record 245 may be generated. The plurality of location data records 245 comprises user web transactions over a period of time, which may be predetermined.

Each location data record 245 comprises location data 246 and access time 247. The access time 247 refers to the time at which the user accessed third-party website 212. Location data record 245 may, in some embodiments, include additional data 248, such as: an identifier for the user, an identifier for third-party website 212, the types of goods or services (e.g., moving services, home improvement stores) offered on the third-party website 212, and more types of data that could improve the accuracy of a change of address prediction model.

In some embodiments, the transaction may be omitted from location database 240 if the location data 246 associated with the transaction matches a known current address of the user. This omittance may be completed at any time throughout the process of collecting location data (e.g., location information) or generating location data records. The purpose of this omittance would be to reduce storage and transmission requirements.

In other embodiments, transactions are not omitted from location database 240 if the location data 246 associated with the transaction matches a known current address of the user. In these embodiments, machine learning model 250 will receive each data record 245 and process the transactions with matching location data according to the trained algorithm.

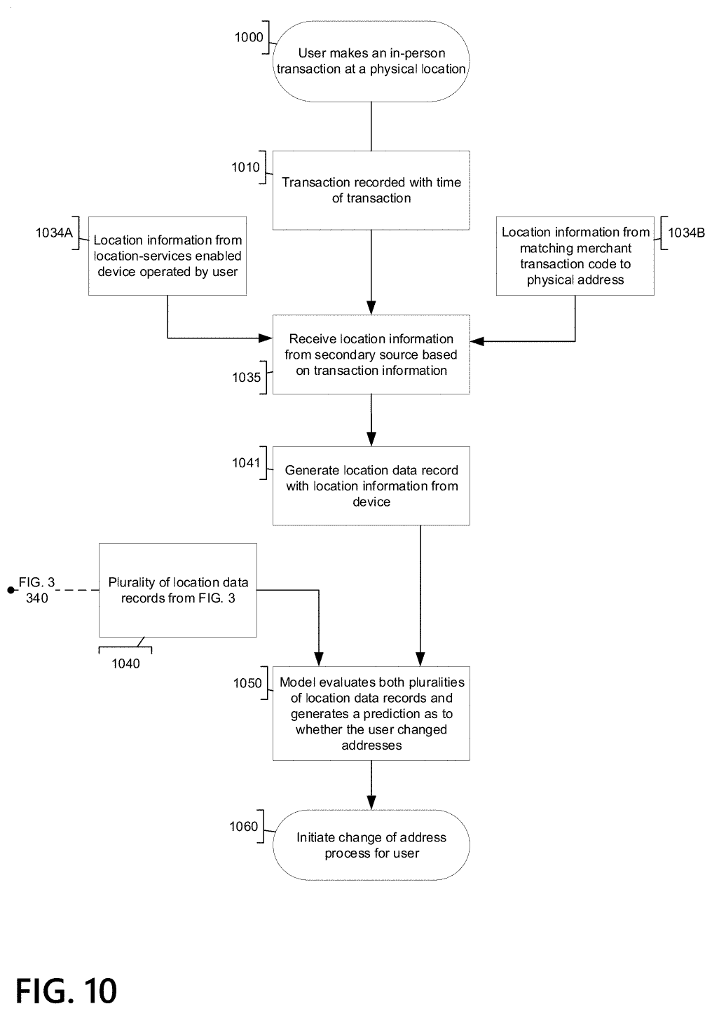

Machine learning model 250 receives location data records 245 from location database 240. Machine learning model 250 analyzes the location data records 245 associated with the user to determine if the user has changed addresses. Prior to analysis, machine learning model 250 may be configured to determine if the user has changed addresses based on user browsing activity by training the model with training data sets, as elaborated further in FIG. 10.

Machine learning model 250 generates a prediction as to whether the user has changed addresses. Based on the prediction indicating a user is likely to have changed addresses, a change of address process may be initiated for the user in step 260.

A change of address process initiated in step 260 may include several different steps or processes. In some implementations, the change of address process may include prompting the user upon their next login to confirm their current address. In other implementations, the change of address process may include flagging the user for internal review by a human analyst. In further implementations, the change of address process may include prompting the user to update the address in a third-party registry, such as the USPS National Change of Address Registry. These embodiments should be considered as examples of potential workflows, and unlisted workflows for the same purpose are also covered by this disclosure.

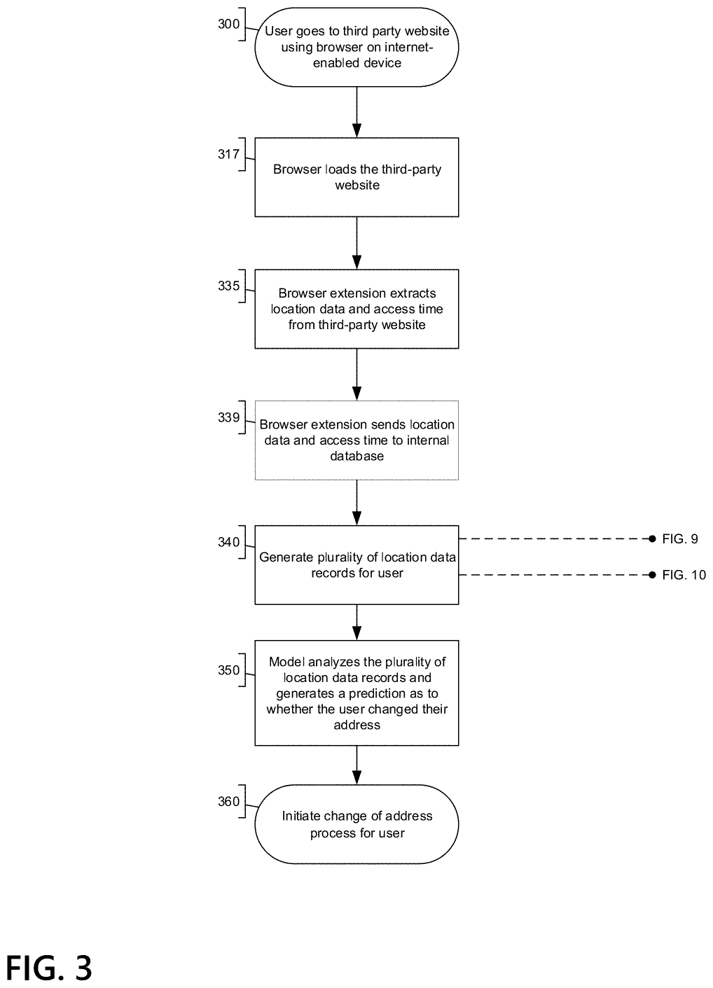

FIG. 3 depicts the method flow for the system shown in FIG. 2.

In step 300, the user goes to a third-party website using a browser on an internet-enabled device. In step 317, the browser loads the third-party website, which will be described in further detail in FIG. 4.

In step 335, the browser extension, similar to browser extension 230 shown in FIG. 2, extracts location information and access time corresponding to the user's browsing activity on the third-party website. In some embodiments, the browser extension may also extract additional data that would be helpful for the change of address prediction in this step. Specific embodiments for how browser extension 230 collects location information will be discussed further in FIG. 4.

In step 339, the browser extension sends the location information and access time to an internal database. This location information and access time may be similar to location data 246 and access time 247 in FIG. 2, respectively. In some embodiments, the browser extension may also send additional data 248 that would be helpful for the change of address prediction in this step.

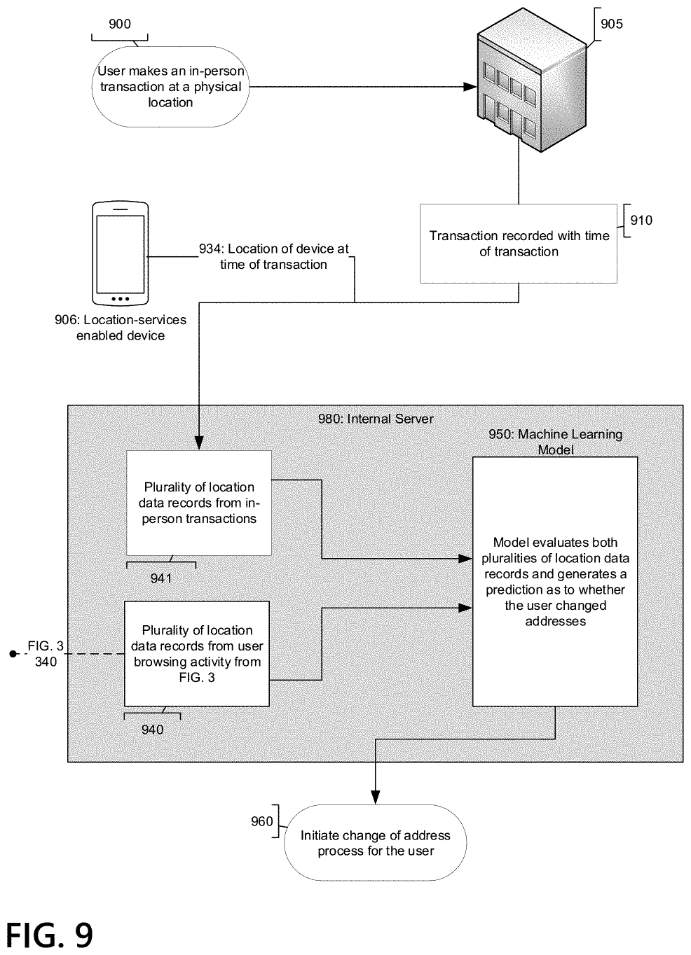

In step 340, the internal database generates location data records, where each location data record comprises location data 246 and access time 247. In some embodiments, each location data record may also include additional data 248 that would be helpful for the change of address prediction. A similar database of location data records may be used in FIGS. 9—10. The database's functionality in those workflows will be discussed with respect to those figures later herein.

Next, in step 350, the machine learning model analyzes the location data records for the user and generates a prediction as to whether the user has changed their address.

If in step 350 the machine learning model generates a prediction that the user has likely changed their address, in step 360, a change of address process may be initiated for the user based on the prediction from step 350. As previously discussed with FIG. 2 in step 260, the change of address process may include prompting the user upon their next login to confirm the current address, flagging the user for internal review by a human analyst, prompting the user to update the address in a third-party registry, and more.

FIG. 4 depicts a method flow for specific methods by the browser extension may the user's location information for step 335 in FIG. 3.

For these methods, the user experience may be similar for all of embodiments, while browser extension 230 collects the location data 246 and access time 247 from different points within the user workflow.

In step 400, the user goes to the third-party website 212 using browser 211 on internet-enabled device 210.

In step 414, browser 211 sends a request to the network for the third-party website, similar to the page request 214 in FIG. 2. This request includes any necessary information to obtain the data for third-party website 212, such as the URL for the third-party website and the IP address of internet-enabled device 210 being used to access third-party website 212.

In step 416, browser 211 receives the response for the third-party website similar to page response 216 in FIG. 2. This response includes any necessary information to load third-party website 212, such as the IP address of third-party website 212, the IP address of the internet-enabled device 210, website content, HTML/CSS formatting, JavaScript to be executed by browser 211, and more.

Next, in step 417, browser 211 begins to load third-party website 212. This step may include constructing the document object model (DOM), executing Javascript functions within the DOM, and more.

In some embodiments, third-party website 212 may include geolocation API requests, and browser 211 executes those API requests in step 418 following step 417. Geolocation APIs may be supported natively by browser 211. Many modern browsers, such as Google Chrome, Apple Safari, Mozilla Firefox, Microsoft Edge, and more support geolocation APIs. The geolocation API used by third-party website 212 may also be incorporated via an external software library that provides additional functionality, ease of use, and other benefits. Owners of third-party website 212 may include geolocation API requests within third-party website 212 to improve the functionality of third-party website 212. For example, third-party website 212 may use the user's geolocation, as requested with the geolocation API, to display information about businesses near the user, filter search results to display results near the user first, determine if locality-specific rules apply to the user, and more.

If third-party website 212 does not include any geolocation API requests, step 418 may not occur. As step 418 may not occur every time the third party website 212 is loaded by the browser 211, it is displayed with a dotted line in FIG. 4.

In some embodiments in which third-party website 212 includes a geolocation API request, browser 211 returns the geolocation API response containing the user's geolocation in step 419. As step 419 may not occur every time the browser 211 requests the user's location, it is displayed with a dotted line in FIG. 4.

In some embodiments, step 419 may be skipped even if step 418 is executed. In these embodiments, third-party website 212 may include a geolocation API request that is executed by browser 211, but does not return a user geolocation. For example, a user may block geolocation API requests from acquiring the user's geolocation by: denying permission when the API requests the user's location; using an adblocker that prevents geolocation APIs from executing; using a browser that blocks geolocation API requests from website that do not use HTTPS protocols; and more.

In step 420 after the previous step(s) (which may be one or a combination of steps 417, 418 or 419), browser 211 finishes loading third-party website 212 and displays third-party website 212 to the user. In some aspects, browser 211 may partially display third-party website 212 while continuing to execute runtime requests, such as geolocation API requests and other APIs included within the page. “Preloading”, or use of other website techniques to improve website display time, should be considered as additional aspects in this disclosure. It will be appreciated that implementations which include a combination of steps 417, 418, and/or 419 may increase efficiencies and provide better results.

Next, in step 421, the user browses third-party website 212.

Browser extension 230 may collect location information and access time at one or more points within the user workflow. A vertical dashed line divides FIG. 4 into a left side, which corresponds to actions taken by the browser, and a right side, which corresponds to actions taken by the browser extension.

These collection methods may be applied individually or in combination and routed to step 435. For example, the process may be routed to step 435 via one or more of steps 434A, 434B, and 434C.

In the implementation shown in step 434A, browser extension 230 intercepts the page request 214, shown in step 414, to collect the IP address of internet-enabled device 210. It will be appreciated that intercepting by the browser extension 230 herein does not necessarily interfere with the browser actions. For example, even if the request in step 414 is intercepted in 434A, the request may continue to the third party web site without interruption and a response may be received in step 416. That is, the browser actions continue when the browser intercepts a request or response such that the browser extension intercepting a request or response does not disrupt the sequence of browser actions, for example, in steps 400-421. The various browser actions and browser extension actions may continue concurrently.

In this implementation, browser extension 230 may collect access time 247 as a timestamp from within page request 214. Browser extension 230 may also determine access time 247 by, for example, independently executing a current timestamp API, or through a different mechanism not dependent on page request 216.

In this implementation, the IP address of internet-enabled device 210 may be the location data 246 collected by browser extension 230. The IP address of internet-enabled device 210 identifies internet-enabled device 210 to other devices on the network. The IP address also provides the location of internet-enabled device 210 to the network for routing purposes. The IP address of internet-enabled device 210 in the page request in step 414 may correspond to the geolocational position of internet-enabled device 210 at the time of the request.

An IP address lookup API, which identifies a geolocational position or region based on an IP address and the public router information included within the IP address, may be used to convert the IP address of internet-enabled 210 to location data 246. This IP address lookup may be performed by browser extension 230 to refine the IP address prior to step 439, or may be performed as part of steps 440 or 450. In some embodiments, machine-learning model 250 from FIG. 2 may also be trained with location information in the form of IP addresses, and the model may analyze the location data in an IP address format without converting the IP address into a geolocational position or region.

In another implementation, which is shown in step 434B, browser extension 230 intercepts the page request 216, shown in step 416, to collect the IP address of internet-enabled device 210.

In this implementation, browser extension 230 may collect access time 247 as a timestamp from within page response 216. Browser extension 230 may also determine access time 247 by, for example, independently executing a current timestamp API, or through a different mechanism not dependent on page request 216.

In this implementation, the IP address of internet-enabled device 210 may be the location data 246 collected by browser extension 230. The IP address may be included in the page response. For example, the IP address may be included as part of the routing information needed for the page response to return to internet-enabled device 210.

Similar to the implementation discussed above, browser extension 230 may convert the IP address into a geolocational position or region using an IP address lookup API. In further aspects, the IP address may be converted in steps 440 or 450. In still other aspects, the IP address may be analyzed in its native format by machine-learning model 250.

In another implementation, shown in step 434C, browser extension 230 intercepts the geolocation API response returned from browser 211 to third-party website 212, shown in step 419, to collect the geolocational position of the user.

In this implementation, browser extension 230 may collect access time 247 as a timestamp from within the geolocation API response in step 419, if a timestamp is included in the geolocation API response. Browser extension 230 may also determine access time 247 by, for example, independently executing a current timestamp API, or through a different mechanism not dependent on the geolocation API.

In this implementation, the geolocational position returned by the geolocation API in step 419 may be the location data 246 collected by browser extension 230. In further aspects, browser extension 230 may make the geolocation API request directly, rather than intercept the response from the browser in step 419.

The implementations described in connection with steps 434A, 434B, and 434C may be implemented individually or in combination. It will be appreciated that combining one or more of the implementations may achieve improved efficiencies and better predictions by more easily detecting changes. For example, the browser extension may intercept any combination of the request for the third party website, the response contain the website display response, and the APR response including the user location.

After collecting location data 246 and access time 247 in step 435, browser extension 230 sends location data 246 and access time 247 to the internal database in step 239. In some aspects, browser extension 230 may also collect additional data 248 as part of step 235 and send additional data 248 to the internal database as part of step 439.

Next, in step 440, similar to step 340 in FIG. 3, the internal database generates location data records, where each location data record comprises location data 246 and access time 247. In some embodiments, each location data record may also include additional data 248.

After step 440, in step 450, the machine learning model analyzes the location data records from step 440 for the user and generates a prediction as to whether the user has changed their address. Step 450 is similar to step 350 from FIG. 3.

If in step 450 the machine learning model generates a prediction that the user has likely changed their address, in step 460 a change of address process may be initiated for the user based on the prediction from step 450. Step 460 is similar to step 360 from FIG. 3.

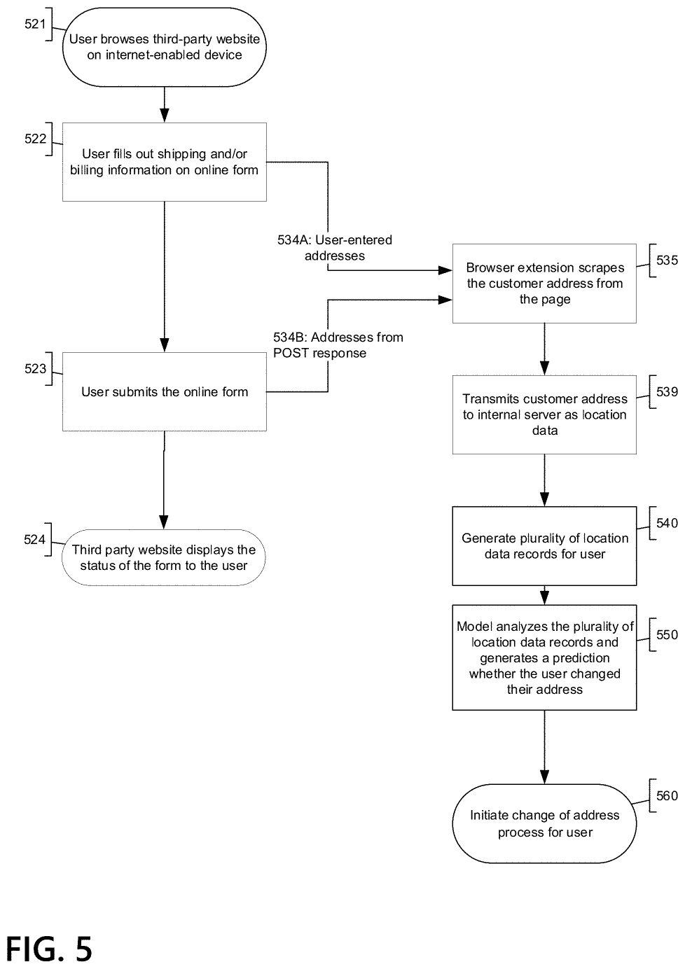

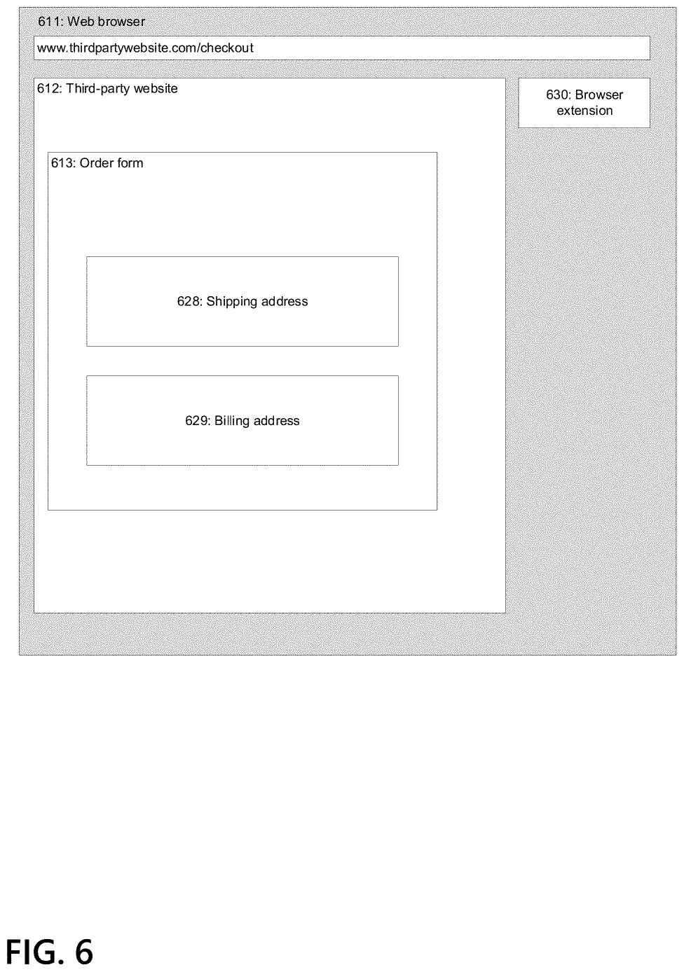

FIG. 5 is a flowchart representation of aspects in which the browser extension scrapes user-entered addresses from the third-party website to use as the location information. FIG. 6 is a representation of an example form on the third-party website that the browser extension would scrape from.

FIG. 5, similar to FIG. 4, has two pathways. The first pathway shows the user's interactions with the third-party website, and the second pathway shows how the browser extension collects location information from those interactions and how that location information may be later used.

As an example, FIGS. 5 and 6 may refer to a user navigating to an online merchant website and selecting goods or services from the merchant, providing shipping and billing information, and completing a purchase. However, this is only one example of a possible environment, and other environments that may require the user to provide an address also would be included in this disclosure.

In step 521, the user may be browsing third-party website 612, as shown in FIG. 6. In the example of an online merchant, the user may be selecting goods or services to purchase.

In step 522, the user enters shipping and/or billing information into the online form. In the example of an online merchant, the user may be filling out online order form 613, as shown in FIG. 6. The user enters the addresses necessary to complete the form; in many embodiments, online order form 613 may require a shipping address 628 and a billing address 629. However, other embodiments may have different addresses; a pickup address, for example, if the user has the goods or services delivered to an external location, with the user traveling to the location to pick up the order. In other embodiments, the shipping address 628 or billing address 629 may also be partial addresses, such as, but not limited to, a zip code in place of a full address, a street address not including an apartment or condo number, and similar address shortenings. In other embodiments, the user may select a pre-saved shipping or billing address from a list rather than enter the address manually, or utilize other techniques to reduce time and/or errors while entering data.

In step 523, the user submits online form 613, which may trigger a request, often an HTTP POST request, to the server for third-party website 612 containing the contents of online form 613. In this step, third-party website 612 may also validate the contents of form 613 before saving the contents. Third-party website 612 may perform this validation on the client side, the server side, or both.

If validating on the client side, a JavaScript function may validate the contents of form 613 before the contents are posted to the server supporting third-party website 612.

If validating on the server side, the server supporting third-party website 612 receives the HTTP POST and then determines if the form contents are valid. If the contents are valid, the server saves the contents of form 613 and returns a success message. If the contents are invalid, the server returns a failure message, which may also include information indicating which field in the form is invalid and why.

In many embodiments, both types of validation may be used for additional security.

After form 613 has been submitted, third-party website 612 may display the results of the form submission to the user in step 524. If the form submission was successful, third-party website 612 may also display a confirmation of the submission for the user; for example, an online order confirmation that includes the new order number generated from the successful submission.

While the user interacts with the page in steps 521, 522, 523, and 524, the browser extension detects that third-party website 612 may have customer addresses on the page.

To identify a potential address field, the browser extension may use JavaScript to collect the HTML elements on the page and evaluate the elements based on type of element, attributes, attached extensions, or other identifying components indicative of an address field.

In some embodiments, the extension script may analyze HTML attributes such as “name”, “input”, “class”, “label”, and “type”. A “label” attribute, for example, may indicate which input element the current element corresponds to, while the displayed value for current element could say “Shipping address”: indicating that the input element, known by the identifying value in the “label field”, will contain a shipping address once the form is filled out. This is one example, used to illustrate a potential method of identifying a shipping address field, and is not exclusive of other techniques to do so.

In other embodiments, the extension script may analyze integrated APIs or extensions that are often used to improve address inputting capabilities; an integrated GoogleMaps search, as one example, or an autocomplete based on known addresses from a delivery company. All of these components should be considered examples of possible embodiments, not limitations on those embodiments, and similar methods or techniques used for adding addresses to a web form should also be considered as covered by this description.

In step 535, after the browser extension has detected that a page has a customer address and identified an address element, the extension may scrape the element for the address provided by the user. Using JavaScript or a similar scraping tool, the extension can capture the value of the inputted address. In some embodiments, this may require scraping multiple elements to obtain all of the pieces of a customer address.

Depending on the stage of the user workflow, the browser extension may scrape different fields within third-party website 612. In aspects such as shown in step 534A, browser extension 630 scrapes the address from online form 613 (without interrupting user interactions with the web page continues (e.g., steps 523-524)), such as the shipping address 628 or billing address 629 as shown FIG. 6. In other aspects such as shown in step 534B, browser extension 630 intercepts the HTTP POST request and scrapes the address from the request (without interrupting user interactions with the web page (e.g., steps 523-524)). In further aspects, if the location information is present on third-party website 612 in step 524, browser extension 630 may scrape the location information from the final page in step 535 (connection line not illustrated).

In step 539, after scraping and collecting an address, the extension may transmit the address, an access time representing the user's interaction with the third-party website, and any additional data to the internal server. In these embodiments, the scraped address represents the location data used in a location data record representing this interaction by the user on this third-party website.

Next, in step 540, the internal database generates location data records, where each location data record comprises location data and access time, and, in some embodiments, additional data that would be helpful for the change of address prediction.

In step 550, the machine learning model analyzes the location data records for the user and generates a prediction as to whether the user has changed their address.

If in step 550 the machine learning model generates a prediction that the user has likely changed their address, in step 560, a change of address process may be initiated for the user based on the prediction from step 550. As previously discussed with FIG. 2 in step 260, the change of address process may include prompting the user upon their next login to confirm the current address, flagging the user for internal review by a human analyst, prompting the user to update the address in a third-party registry, and more.

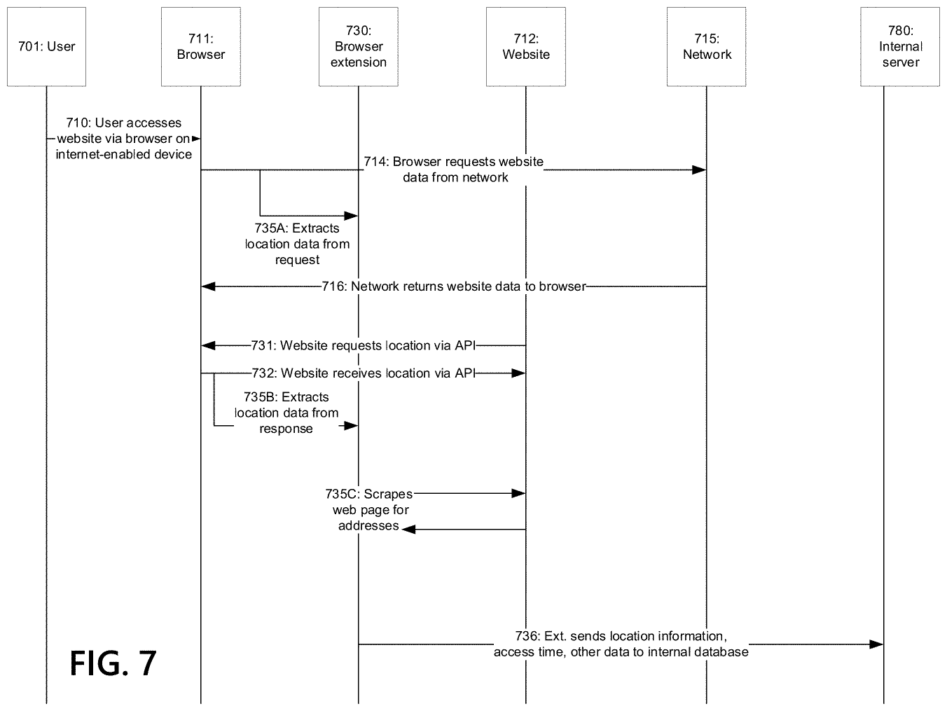

FIG. 7 depicts the movement of the location data as shown in FIGS. 2-5, from the third-party website 712 when accessed by user 701 in step 710.

In step 714, browser 711 requests data for third-party website 712 once user 701 accesses the website in step 710. Network 715 returns a page response in step 716 to browser 711, which displays the website 712.

In some embodiments, browser extension 730 obtains the location information by extracting the information from the page request 735A. A similar workflow is depicted in further detail in FIG. 4.

In other embodiments, browser extension 730 may obtain the location information by extracting the information from a geolocation API request 731 made by third-party website 712. In these other embodiments, browser extension 730 may intercept the geolocation API response in step 732 from browser 712 that contains the user location information in step 735B. A similar workflow is depicted in further detail in FIG. 4.

In other embodiments, browser extension 730 may obtain the location data by scraping an order form on website 712 to obtain user-entered shipping or billing addresses in step 735C. A similar workflow is depicted in further detail in FIG. 5.

After each of steps 735A, 735B, and 735C, in step 736, browser extension 730 then sends the user location data, access time, and any other desired information to location database in internal server 780, which generates a plurality of location data records as shown in FIG. 3.

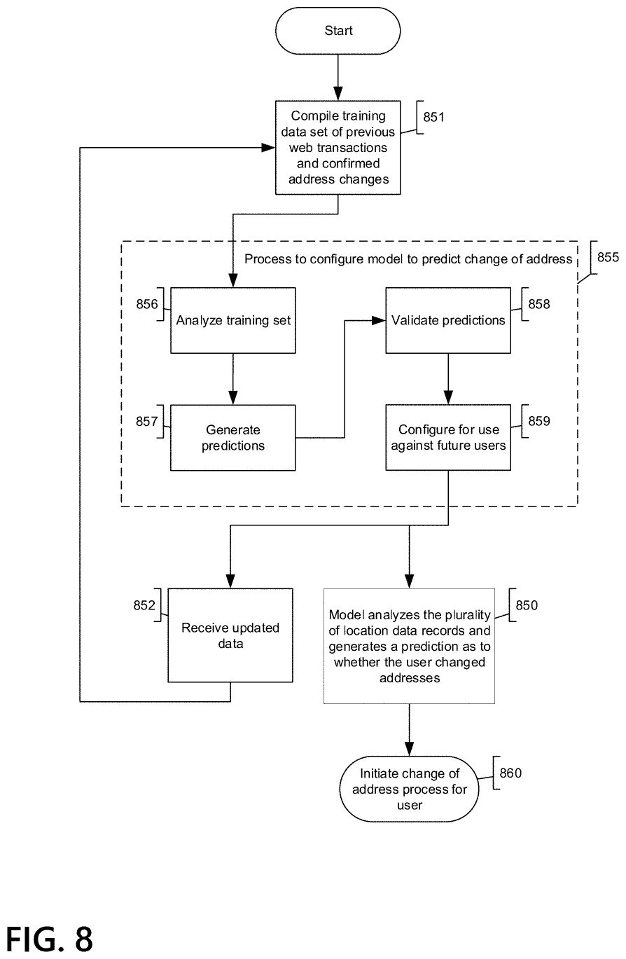

FIG. 8 depicts the configuration process for the machine-learning model to analyze the location data records and generate a prediction as to whether the consumer changed addresses.

First, a training set may be compiled in step 851. The training set may be based on previous consumer web transactions and confirmed address changes for a plurality of users. The training set may be compiled based on data collected from the browser extension through the embodiments depicted in FIGS. 2-7. The training set may also be compiled based on data obtained through other mechanisms, such as previously submitted change of addresses from current consumers, change of addresses from a third-party database, or similar methods of gathering data.

The machine-learning model analyzes training set in step 856 and generates interim predictions in step 857. These predictions are validated against the known addresses of the consumers within the training set in step 858. The machine-learning model then incorporates the validations and improves the model by cycling through the analysis, prediction, and validation process until the model is configured for future users in step 859.

After being configured for use, in step 859, the machine-learning model analyzes location data records as generated by the aspects previously described and generates predictions in step 850. Based on predictions that the user has likely changed their address, change of address processes may be initiated for a consumer in step 860.

Also, after step 859, the machine-learning model may be updated over time with new training sets in step 852. In this step, the model may receive new sets of data and iterate through the process previously described in steps 851, 856, 857, 858, and 859. These new sets of data may include additional data points, new consumer records, and other data that might be useful. These training sets may be obtained from third parties or compiled based on the location data records generated from the aspects described previously in FIGS. 2-7. After completing the training steps 856, 857, 858 and 859, the machine-learning model can again be used for analysis of the location data records generated by the aspects previously described in step 850 and the initiation of change of address process in step 860.

FIGS. 9 and 10 display embodiments in which the primary method of collecting location data from the user's behavior on third-party websites may be supplemented with location data from the user's in-person transactions at physical locations. FIG. 9 shows an environment in which a user makes in-person transactions. FIG. 10 displays a flowchart model of the collection method of location information for FIG. 9 and how it supplements the aspects previously described in FIG. 3.

FIG. 9 depicts a user interaction in which a user makes an in-person transaction in step 900 at physical location 905. The transaction may be recorded in step 910, with the time of transaction also recorded.

At the same time, location services-enabled device 906, operated by the user, tracks the current location of the user. The location-serviced enabled device 906 may be, but is not limited to, a mobile smartphone, a tablet, a Bluetooth dongle, a location-services enabled vehicle, or other similar devices. The location-services enabled device 906 may be an example of device 108 in FIG. 1.

In step 934, location-services enabled device 906 provides the user's location at the time of the transaction from step 900. How the location may be provided will be discussed in further detail in FIG. 10.

The location data from step 934 and the time of transaction from step 910 are sent to a location database on internal server 980. In step 941, the location database generates location data records based on the location data from step 934 and time of transaction from step 910. The process of generating location data records in step 941 is similar to step 340 in FIG. 3.

The location data records from the user browsing information are also included in the analysis, as represented by step 940. These records would be generated according to the process previously described in FIG. 3, and as such are represented with a dotted line leading back to step 340 in FIG. 3.

In step 950, the machine learning model evaluates both sets of location data records and generates a prediction as to whether the user has changed addresses. This model would be trained similarly to the model described in FIG. 8, with the addition of training data including in-person transactions as well as online transactions.

In step 960, based on the prediction from step 950 indicating that the user has likely changed their address, a change of address process may be initiated for the user. This step may be considered similar to step 360 in FIG. 3 and is enumerated in more detail in FIG. 3.

FIG. 10 displays a flowchart representation of the user interaction and data collection methods shown in FIG. 9.

In step 1000, the user makes an in-person transaction at a physical location, shown as 905 in FIG. 9.

In step 1010, the in-person transaction may be recorded with, at minimum, a time of transaction. It may also be recorded with other information associated with the transaction, such as a “merchant code” identifying the physical location, the name of the business, the type of goods or services purchased, the cost of the purchase, and more.

Next, in step 1035, the location information associated with the in-person transaction may be collected using the transaction information recorded in step 1010. Illustrative aspects for this collection are shown, in step 1034A and step 1034B.

In illustrative aspects according to step 1034A, the location information may be obtained from a location-services enabled device operated by the user, and displayed as 906 in FIG. 9.

In some aspects in which location-services enabled device 906 is a smartphone, an application installed on location-services enabled device 906 may be used to obtain the user's location at a time corresponding to the transaction. In these aspects, the application may receive an update corresponding to the time of the user transaction at the physical location in step 1010, get the user's current location via a location services API, and provide that location as location data for a location data record corresponding to this transaction.

In further illustrative aspects, an internal server, such as internal server 980 in FIG. 9, may receive a transaction record and then send a request to a predetermined location-services enabled device to get the current location of the device.

In some of these further illustrative aspects, if the location information for the transaction received from the location-services enabled device 906 matches a known current address for the user, the transaction may be omitted from the location data records for the in-person transactions. This omission may be completed at any time throughout the process of collecting location information or generating location data records.

In illustrative aspects according to step 1034B, the location information may be received by matching information on the transaction to a physical address.

In these illustrative aspects, the transaction may be recorded at an internal server with a “merchant code” identifying the physical location, as shown at 905 in FIG. 9.

This “merchant code”, which does not necessarily contain a human-readable address or geolocational coordinates, is used to look up the geolocational coordinates. A database matching merchant codes to location information identifying the location of that store, such as geolocational coordinates, may be used to retrieve the corresponding location information for the transaction. The database may also index other data, such as codes identifying a merchant chain in the case of a merchant with multiple locations, and classifications for the types of goods and services offered by the merchant, etc. The location information may also be in a different format, such as addresses rather than geolocation coordinates.

The illustrative aspects according to step 1034A and step 1034B may be used in combination or used separately, depending on the system resources available. They may also be used in combination with other methods of identifying the location information for in-person transactions.

In step 1041, the location database generates location data records based on the location information collected in step 1035 and the time of transaction from step 1010. The process of generating location data records in step 1041 is similar to that of step 340 in FIG. 3.

The location data records from the user browsing information are also included in the analysis, as represented by step 1040. These records would be generated according to the process previously described in FIG. 3, and as such is represented with a dotted line leading back to step 340 in FIG. 3.

In step 1050, the machine learning model evaluates both sets of location data records and generates a prediction as to whether the user has changed addresses. This model would be trained similarly to the model described in FIG. 8, with the addition of training data including in-person transactions as well as online transactions.

In step 1060, based on the prediction indicating that the user has likely changed their address in step 1050, a change of address process is initiated for the user. This step may be considered similar to step 360 in FIG. 3 and is enumerated in more detail in FIG. 3.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
receiving, via a browser extension executing on a user device, location data associated with a user based on user browsing activity in a browser application accessing a third-party website;
generating a first plurality of location data records associated with the user based on the user browsing activity, wherein each location data record of the first plurality of location data records comprises:
location data corresponding to a respective page access of the user browsing activity, and
an access time corresponding to the respective page access;
generating, by a machine learning model and based on the first plurality of location data records associated with the user, a prediction as to whether the user has changed addresses, wherein the machine learning model is configured to evaluate a likelihood that a user has changed addresses based on a plurality of location data records associated with user browsing activity over a period of time; and
based on the prediction from the machine learning model indicating that the user is likely to have changed addresses, initiating a change of address process for the user.

2. The method of claim 1, wherein the location data is based on location information provided by the browser application in a page request for the third-party website, wherein the location information is extracted from the page request for the third-party website by the browser extension.

3. The method of claim 1, wherein the location data is based on geolocation information provided by the browser application in a response to a geolocation application programming interface (API) request from the third-party website, wherein the geolocation information is extracted by the browser extension from the response.

4. The method of claim 1, wherein the location data is based on location information provided by the browser to the browser extension in response to a request from the browser extension to the browser to provide the location information.

5. The method of claim 1, wherein the location data is obtained through the browser extension scraping a web page associated with the third-party website to determine an address associated with a transaction.

6. The method of claim 1, wherein the location data comprises a shipping address associated with a transaction of the user on the third-party website.

7. The method of claim 1, wherein the location data comprises a billing address associated with a transaction of the user on the third-party website.

8. The method of claim 1, wherein generating the first plurality of location data records comprises:
determining if location data corresponding to a second transaction of the user matches a known address of the user; and
omitting the second transaction from the first plurality of location data records if the location data corresponding with the second transaction matches a known address of the user.

9. The method of claim 1, further comprising:
determining, by the browser extension, a shipping address or billing address associated with a transaction of the user on the third-party website;
evaluating the shipping address or billing address against a known address of the user; and
generating a value indicating whether the shipping address or billing address matches a known address of the user,
wherein the received location data comprises the value and does not include the shipping address or billing address.

10. The method of claim 1, wherein initiating the change of address process comprises prompting the user to confirm their current address.

11. The method of claim 1, wherein initiating the change of address process comprises prompting the user to update their address in a third-party registry.

12. The method of claim 1, further comprising:
retrieving, based on transaction records corresponding to the user, additional location data associated with in-person transactions of the user; and
generating a second plurality of location data records associated with the user based on the in-person transactions, wherein each location data record of the second plurality of location data records comprises:
location data corresponding to a respective in-person transaction of the user, and
a time of transaction corresponding to the respective in-person transaction,
wherein generating the prediction as to whether the user has changed addresses is further based on the second plurality of location data records.

13. The method of claim 12, wherein retrieving location data associated with the in-person transactions of the user comprises:
determining a physical address of a merchant corresponding to a given in-person transaction, wherein the location data of the location data record corresponding to the given in-person transaction is based on the physical address of the merchant.

14. The method of claim 12, where retrieving location data associated with the in-person transactions of the user comprises:
receiving, via a request to a location services-enabled device associated with the user, location information corresponding to a location of the location-services enabled device at a time corresponding to a given in-person transaction,
wherein the location data of a location data record corresponding to the given in-person transaction is based on the location information received from the location-services enabled device.

15. The method of claim 14, further comprising:
determining whether second location information received from the location-services enabled device, corresponding to a second in-person transaction of the user, matches a known address of the user, and
omitting the second transaction from the second plurality if the location data corresponding with the second in-person transaction matches a known address of the user.

16. A computing device, comprising:
one or more processors; and
memory storing instructions that, when executed by the one or more processors, cause the computing device to:
receive, via a browser extension executing on a user device, location data associated with a user based on user browsing activity in a browser application accessing a third-party website, wherein the location data is based on location information provided by the browser application in a page request for the third-party website;
generate a plurality of location data records associated with the user based on the user browsing activity, wherein each location data record of the plurality of location data records comprises:
location data corresponding to a respective page access of the user browsing activity, and
an access time corresponding to the respective page access;
generate, by a machine learning model and based on the plurality of location data records associated with the user, a prediction as to whether the user has changed addresses, wherein the machine learning model is configured to evaluate a likelihood that a user has changed addresses based on a plurality of location data records associated with user browsing activity over a period of time; and
based on the prediction from the machine learning model indicating that the user is likely to have changed addresses, initiate a change of address process for the user.

17. The computing device of claim 16, wherein the location data is based on geolocation information provided by the browser application in a response to a geolocation application programming interface (API) request from the third-party website, wherein the geolocation information is extracted by the browser extension from the response.

18. The computing device of claim 16, wherein the instructions cause the computing device to initiate the change of address process by causing the computing device to:
prompt the user to confirm their current address; or
prompt the user to update their address in a third-party registry.

19. One or more non-transitory computer-readable media storing instructions that, when executed by one or more processors, cause a computing device to perform steps comprising:
receiving, via a browser extension executing on a user device, location data associated with a user based on user browsing activity in a browser application accessing a third-party website, wherein the location data is obtained through the browser extension scraping a web page associated with the third-party website to determine an address associated with a transaction of the user;
generating a plurality of location data records associated with the user based on the user browsing activity, wherein each location data record of the plurality of location data records comprises:
location data corresponding to a respective page access of the user browsing activity, and
an access time corresponding to the respective page access;
generating, by a machine learning model and based on the plurality of location data records associated with the user, a prediction as to whether the user has changed addresses, wherein the machine learning model is configured to evaluate a likelihood that a user has changed addresses based on a plurality of location data records associated with user browsing activity over a period of time; and,
based on the prediction from the machine learning model indicating that the user is likely to have changed addresses, initiating a change of address process for the user.

20. The computer-readable medium of claim 19, wherein the address obtained through the browser extension is a shipping address or a billing address included in the scraped web page.
